(19) United States
(12) Patent Application Publication
(10) Pub. No.: US 2017/0071190 A1
(43) Pub. Date: Mar. 16, 2017

(54) TURKEY GOBBLER VOCALIZATION DETECTION APPARATUS

(71) Applicant: John R. Lewis, Tallahassee, FL (US)

(72) Inventor: John R. Lewis, Tallahassee, FL (US)

(21) Appl. No.: 14/855,988

(22) Filed: Sep. 16, 2015

(51) Int. Cl. A01M 31/00; G08B 5/38; H04R 1/34; G10L 17/26; G10L 25/51

(52) U.S. Cl. CPC A01M 31/002; G10L 17/26; G10L 25/51; H04R 1/342; G08B 5/38

(57) ABSTRACT

Embodiments described herein include a turkey gobbler vocalization detection apparatus that is designed to collect, analyze, and store a turkey gobble vocalization over a period of time. The apparatus contains a parabolic collector, microphone, amplifier, analog-to-digital converter, audio digital signal processor, internal light, and a display unit within a housing element which is configured to be deployed in one of a plurality of wildlife environments. If a vocalization is detected, it is received, filtered, and analyzed using a Fourier analysis. If a detected spectra signature is within a range of a pre-programmed spectral signature signal of a turkey gobble, then the detected spectra signature, and at least the time and recording of the detected spectra signature are stored within an on-board memory module. Simultaneously, an output signal is sent to an internal light source to notify a user that a detected spectra signature is stored within the on-board memory module, and allow the user to access a 1-15 second incremental recording of the detected spectra signature using a five push-button display unit while a notification is transmitted over a wireless network.

### FIELD

The present embodiment relates to a male turkey (gobbler) vocalization detection apparatus, and in particular, a turkey gobbler vocalization detection apparatus that is able to collect, analyze, store, and transmit vocalization data of a turkey gobble for an indefinite period without requiring further integration from an external source.

### BACKGROUND

The origins of turkey detection and tracking date back to the Native Americans who hunted the four species of North American wild turkey before European settlers arrived. As the population of the continent continued to grow and settlers migrated west, their reliance on the wild turkey as a food source increased.

At one time in the United States, the population of wild turkey was estimated to be as low as 30,000. Currently, the turkey population in North America exceeds 7 million, creating an abundant population and prompting many states to extend hunting seasons for the estimated 2.8 million turkey hunters in the United States.

One of the most proven methods of attracting a male turkey or gobbler is to mimic the vocalizations of a female turkey or hen by using a “call.” These air and friction actuated devices have been used by hunters for centuries to mimic the distinctive calls of the hen turkey, such as the “cluck, yelp, and purr” among others, thus prompting the gobbler to search and approach the source of the call. However, a hunter must still scout potential hunting grounds for gobbler populations, and listen for the distinctive gobbler call to identify the presence of the sought-after game bird in the area. On large tracts of land, this is made more difficult by the fact that a hunter or scout can only listen in one area at a time.

Currently, there are several devices on the market that may be deployed into a wildlife environment to monitor and record animal vocalizations. Specifically, U.S. Pat. No. 5,239,587 to Muckelrath; U.S. Pat. No. 8,457,962 to Jones; and U.S. Pat. No. 5,452,364 to Bonham. However despite their respective advantages, these embodiments are limited in their capability to analyze, store, and transmit turkey vocalization data without further integration with an external electronic computation device.

### SUMMARY OF THE INVENTION

Embodiments described herein include a turkey gobbler vocalization detection apparatus. Embodiments include at least one receiving unit with a parabolic reflector designed to collect and direct sound waves to an omnidirectional microphone to be converted to an electrical signal where it can be filtered, converted to a digital signal, and analyzed using an audio digital signal processor. If the sound is within the selected spectral signature of 200 to 4000 Hz, the integrated frequency analyzer and on-board memory module of the audio digital signal processor will compare the detected sounds with a pre-programmed host of recorded turkey gobbles to identify a possible match. If the frequency analyzer determines the detected spectra signature to be a match, it will then record a 1-15 second incremental recording of the detected turkey gobble (i.e., detected spectra signature) along with the date and time. The detected spectra signature may be stored within the onboard memory module for an indefinite period of time and may be accessed using a push-button liquid crystal display unit which may further play back the detected spectra signature and exhibit at least the date and time. Simultaneously, a user may be alerted of the detected spectra signature by viewing a light-emitting diode visible through a translucent portion of the housing element and through a smart device notification received over a wireless network Additionally, a user may receive notification of a detected frequency through a smart device communication received via a wireless network.

Other aspects, advantages, and novel features of these embodiments will become apparent from the following detailed description in conjunction with the drawings.

### BRIEF DESCRIPTION OF THE DRAWINGS

A more complete understanding of these embodiments, and the attendant advantages and features thereof, will be more readily understood by reference to the following detailed description when considered in conjunction with the accompanying drawings wherein:

FIG. 1 is a perspective view of a turkey gobbler vocalization detection apparatus; and

FIG. 2 is a block diagram of the turkey gobbler vocalization detection apparatus.

### DETAILED DESCRIPTION

The specific details of the single embodiment or variety of embodiments described herein are set forth in this application. Any specific details of the embodiments are used for demonstration purposes only and no unnecessary limitations or inferences are to be understood therefrom.

The embodiments shown relate to a turkey gobbler vocalization detection apparatus. The apparatus may be placed in one of a plurality of wildlife environments to collect, analyze, store, and transmit turkey gobbler vocalization data over a period of time without necessary further integration from an external source. Specifically, the apparatus is configured to monitor and filter for a spectra signature corresponding to a turkey gobble. The detected spectra signature is then passed through a band pass filter and compared with a pre-programmed spectral signature corresponding to a turkey gobble using a pre-programmed software utilizing Fast Fourier Transform (FFT) principles. If the detected spectra signature and the pre-programmed spectral signature corresponding to a turkey gobble share specific wavelength characteristics such as comparing the distance between corresponding points on a the same phase such as crest, troughs, or zero cross points, then the frequency analyzer will establish match. If the detected spectra signature is found to be a match, then at least the date, time, and a 1-15 second incremental recording of the detected spectra signature will be stored using the on-board real time clock and onboard memory module. Simultaneously, an output signal will be sent from the audio digital signal processor to a light emitting diode to notify a user that a detected spectra signature has been recorded. A user may access this recorded information at a five push-button gray scaled liquid crystal display unit, wherein the stored recording will remain within the onboard memory module for an indefinite period of time. Further, a user will receive a notification on their smart device over a wireless network that a detected spectra signature has been established as a match and has been stored with the onboard memory module.

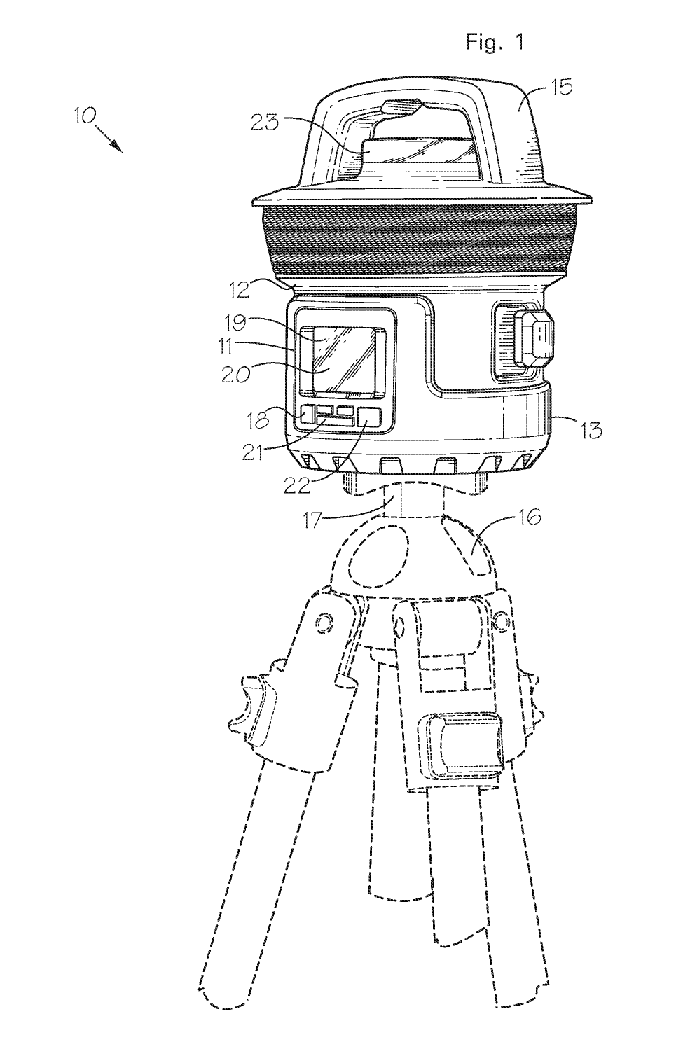

Referring now to the drawings wherein like reference numerals designate identical or corresponding parts throughout the views, there is shown in FIG. 1 a perspective view of a turkey gobbler vocalization detection apparatus 10. In the embodiment shown in FIG. 1, the turkey gobbler vocalization detection apparatus 10 is comprised of an elongated and substantially cylindrical case 11 with a first section 12 and a second section 13 which are removably affixed to allow access to at least one component enclosed therein. The first section 12 and the second section 13 are constructed of an injection molded thermoplastic which are connected using a thermoplastic weathering strip to create a hermetic seal and prevent water intrusion. The turkey gobbler vocalization detection apparatus 10 further includes a handle 15 configured to enable a user to either carry or hang the apparatus 10 while deployed in a wildlife environment. The elongated and substantially cylindrical case 11 further includes a second section 13 which releasably secures the apparatus to a stand 16 at the desired height using a receiving coupling 17.

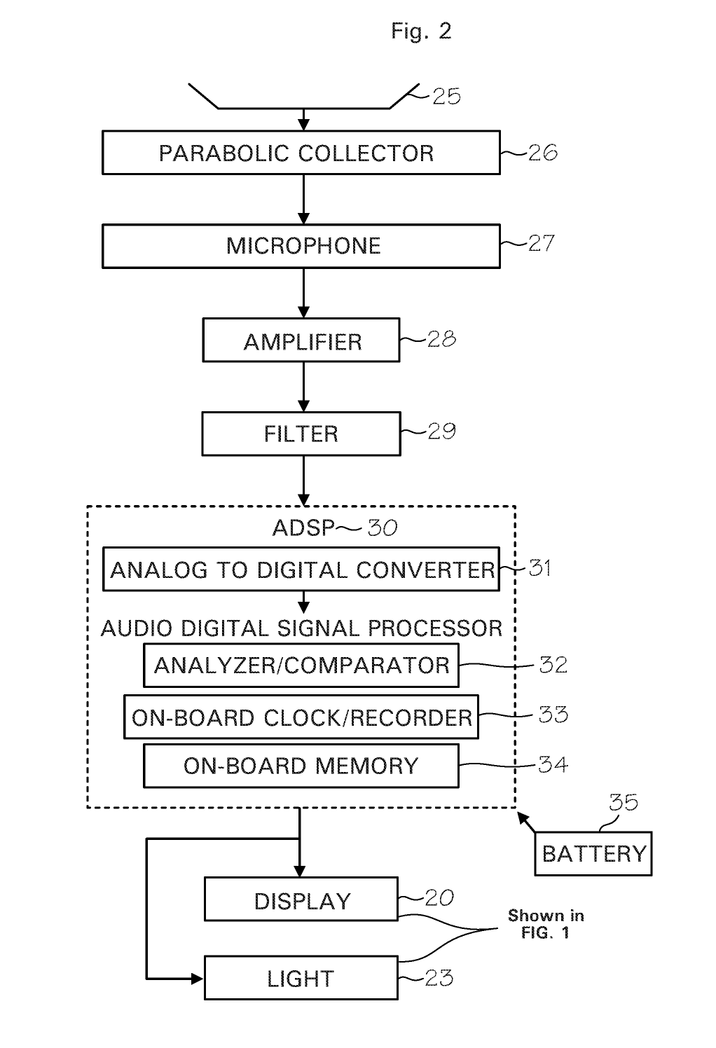

The turkey gobbler vocalization detection apparatus 10 is energized by depressing a power button 18 located on a display unit 19. The display unit 19 further includes a gray-scaled liquid crystal display screen 20, and a plurality of push-buttons 21 that enable a user to access a plurality of stored turkey gobbler vocalization data (i.e., detected spectra signatures), as shown in FIG. 2. The gray-scaled liquid crystal display screen 20 is further comprised of a plurality of liquid crystals configured to modulate existing background light to depict at least fixed images, digits, and a digital clock while minimizing power consumption. The plurality of push-buttons 21 enable a user to scroll through a “menu” and view a plurality of stored detected spectra signature data or playback a 1-15 second incremental recording of a stored spectra signature using an input jack 22. Further, the turkey gobbler vocalization detection apparatus 10 provides visual notification that a detected spectra signature has been recorded and stored within the memory module by an alternately flashing colored light source 23 which is visible through a translucent portion of the housing element 24. The light source 23 enables the user to be notified of a stored detected spectra signature without the inconvenience of having to continuously re-visit the apparatus 10 and access the display unit 19.

FIG. 2 provides a block diagram of the turkey gobbler vocalization detection apparatus 10 wherein the receiving unit 25 further includes at least one parabolic collector 26 and at least one microphone 27. The at least one parabolic collector 26 may include a highly reflective material configured in a parabolic geometry to collect an incoming sound wave traveling about a plane into a spherical wave converging toward a focal point. This parabolic geometry ensures any spherical aberration is corrected before arriving at the diaphragm of the microphone 27 and providing a maximum receiving capability.

The at least one microphone 27 uses a micro-electrical mechanical induction to vibrate a pressure-sensitive diaphragm and convert an incoming sound wave into an auditory electric analog signal where it can be processed and amplified using an integrated pre-amplifier. Further, the at least one microphone's 27 pre-amplifier is configured to increase the auditory analog signal strength and minimize interference. Further, the at least one omnidirectional microphone can be configured in a plurality of positions and would optimally be spaced 180 degrees apart about the at least one parabolic collector 26 to avoid interference.

The turkey gobbler vocalization detection apparatus 10 further amplifies the auditory electric analog signal using at least one amplifier 28. The amplifier 28 is electrically connected to a filter 29 and configured to reproduce an output signal with a larger amplitude than the input signal. The at least one frequency filter 29 is configured to receive an electric auditory analog signal and attenuate spectra signatures not corresponding with a turkey gobble using at least one band pass filter. The at least one band pass filter is designed to pass only frequencies within a spectral signature of 200-4000 Hz utilizing a flat passband to minimize gain/attenuation throughout.

The turkey gobbler vocalization detection apparatus 10 converts, analyzes, and stores any recorded detected spectra signatures using an audio digital signal processor 30. The audio digital signal processor 30 includes a plurality of embedded components such as an analog-to-digital converter 31, a frequency analyzer 32, an onboard clock 33, and at least one onboard memory module 34. The analog-to-digital converter 31 further includes a 10-bit successive approximation registry that converts the auditory analog signal to a 10-bit digital representation using at least one sample-and-hold circuit.

The frequency analyzer 32 includes at least one secure digital high capacity memory card with integrated software including a plurality of pre-programmed spectral signatures corresponding to a turkey gobble to be analyzed with a detected spectra signature. The integrated software includes a plurality of pre-programmed spectral signatures which compares the detected spectra signature using a Fourier analysis to analyze fundamental and harmonic characteristics of the detected spectra signature for a possible match using the frequency analyzer 32. For example, the Fourier analysis samples different points by comparing distances between corresponding points on a same phase of the detected spectra signature with a pre-programmed spectral signature. This sampling includes comparing a crest, trough, or zero crossing point (i.e., zero amplitude). If the distances between the corresponding points are similar then frequency analyzer 32 will establish a match.

Conversely, if a detected spectra signature does not share any fundamental and harmonic characteristics with one of a plurality of pre-programmed spectral signatures the frequency analyzer 32 will cease comparing signatures and return to monitoring for a new vocalization.

The onboard clock 33 is designed to indicate, maintain and co-ordinate time, and provide a time stamp when a detected spectra signature is stored within the onboard memory module 34. Further, the onboard clock 33 is programmable to indicate activation/deactivation times for the apparatus 10. For example, a user may determine that the apparatus should be activated from 6 a.m. to 6 p.m., in which case the apparatus 10 will be deactivated outside the pre-programmed time period, in which only the onboard clock 33 will continue to run; while other components enter a low power mode.

The apparatus 10 is powered by at least one battery 35 electrically connected to the audio digital signal processor 30 and configured to provide a continuous flow of electrical energy to the apparatus 10.

The apparatus 10 further includes a wireless transmitter configured to modulate that a detected spectra signature has been recorded to a user via a wireless network such as a telephonic, cellular, or wireless wide-area network. For example, if a detected spectra signature has been recorded, a user will be notified on a smart device of the recording along with date and time. This data may be communicated to the user using a transmitter or terminal over a wireless network through radio frequencies.

It will be appreciated by persons skilled in the art that the present embodiment is not limited to what has been particularly shown and described herein above. In addition, unless mention was made above to the contrary, it should be noted that all of the accompanying drawings are not to scale. A variety of modifications and variations are possible in light of the above teachings without departing from the following claims.

1. A turkey gobbler vocalization detection apparatus, comprising:
a housing element including a translucent portion to enable an internal flashing colored light to be seen from outside the housing element when a turkey gobble signal is detected;
a parabolic collector connected to the housing element and configured to receive sound waves and direct the sound waves toward a microphone;
at least one microphone positioned at about a focal point of the parabolic collector, that at least one microphone producing an analog electrical signal representative of the sound waves received by the parabolic collector;
an analog-to-digital converter configured to convert the analog electrical signal to a digital signal;
an audio digital signal processor configured to:
receive the digital signal;
analyze the digital signal to detect the turkey gobble signal;
record a time of detecting the turkey gobble signal; and
cause a display of the time of detecting the turkey gobble signal;
a display to exhibit the time of detecting the turkey gobble signal; and
a transmitter to perform a communication of detecting the turkey gobble signal over a wireless network.

2. The apparatus of claim 1, wherein the housing element includes an upper and lower portion, the upper portion having a handle to allow a user to carry the device with a single handle and the lower portion configurable to be releasably attached to a stand.

3. The apparatus of claim 2, wherein the housing element is hermetically sealed.

4. The apparatus of claim 1, further comprising an amplifier to amplify the analog electrical signal.

5. The apparatus of claim 1, wherein the audio digital signal processor further includes a band pass filter configured to pass signals in a selected frequency band corresponding to a turkey gobble.

6. The apparatus of claim 1, wherein the audio digital signal processor includes a pre-programmed on-board memory module configured to store a pre-programmed spectral signature and a comparator configured to compare a selected spectra signature with the pre-programmed spectra signature, the pre-programmed spectral signature corresponding to a turkey gobble.

7. The apparatus of claim 1, further comprising a light to light up when the turkey gobble signal is detected.

8. The apparatus of claim 1, further comprising an on-board memory module to store data corresponding with detected turkey gobble signal over a period of time.

9. The apparatus of claim 8, wherein the data corresponding with detected turkey gobble signals over a period of time include the date and time the turkey gobble signal was detected, and the number of times the turkey gobble signal was detected.

10. The apparatus of claim 1, wherein the display unit is connected to the on-board memory module and configured to display the data corresponding with detected turkey gobble signals.

11. A turkey gobbler vocalization detection apparatus, comprising:
a housing element, the housing element upper and lower portions, the upper portion further including a translucent portion configured to enable an internal flashing colored light to be visible from outside the housing element when a turkey gobble signal is detected, and the lower portion further including a receiving coupling to enable a stand to be releasably attached;
a parabolic collector connected to the housing element and configured to direct a sound wave toward a focal point;
at least one amplifier connected to an audio digital signal processor and configured to amplify the analog electrical signal;
an analog-to-digital converter configured to convert the amplified analog electrical signal into a digital signal;
an audio digital signal processor configured to:
compare the digital signal with a pre-programmed spectral signature signal corresponding to a turkey gobble using at least one comparator;
record a time of detecting a turkey gobble signal using at least one on-board clock:
store at least one detected turkey vocalization for a period of time;
cause a display of the time of detecting the turkey gobble signal by receiving a signal from at least one register;
a liquid crystal display to exhibit a time of the at least one detected turkey vocalization; and
a wireless transmitter to provide a direct communication of at least one detected turkey vocalization to at least a smart device.

12. The apparatus of claim 11, wherein the at least one frequency filter further includes a band pass filter configured to pass a digital signal corresponding to a turkey gobble.

13. The apparatus of claim 11, wherein the comparator further includes an integrated software component to compare the digital signal with the pre-programmed spectral signature signal corresponding to a turkey gobble using Fast Fourier Transform.

14. The assembly of claim 13, wherein the integrated software component of the comparator is configured to compare the digital signal with the pre-programmed spectral signature signal corresponding to a turkey gobble using a Fourier analysis.

15. The apparatus of claim 14, wherein the pre-programmed algorithm is further configured to measure a spectral magnitude of the detected spectra signature with a spectral magnitude of the pre-programmed spectral signature corresponding to a turkey gobble.

16. The apparatus of claim 15, wherein the pre-programmed algorithm is further configured to measure a phase of the detected spectra signature spectral magnitude with a phase of the pre-programmed frequency corresponding to a turkey gobble's spectral magnitude by measuring a distance between a point of the detected spectra signature with at least a corresponding point of the pre-programmed spectral signature corresponding to a turkey gobble.

17. The apparatus of claim 16, wherein the corresponding point further includes at least a zero crossing wherein the pre-programmed algorithm measures a phase difference between the spectral magnitude of the detected spectra signature and the spectral magnitude of the pre-programmed spectral signature signal corresponding to a turkey gobble.

18. The apparatus of claim 15, wherein the integrated software of the comparator is further configured to compare a wavelength period of the digital signal with a wavelength period of the pre-programmed spectral signature signal corresponding to a turkey gobble.

19. The apparatus of claim 11, wherein the display unit includes a push-button gray scaled liquid crystal display including at least five buttons.

20. A turkey gobbler vocalization detection apparatus, comprising:
a housing element, the housing element configured to releasably contain an audio digital signal processor, and further configured to include an upper and lower portion; the upper portion further including a translucent portion to enable an internal flashing colored light emitting diode to be visible from outside the housing element when a when a turkey gobble signal is detected, and the lower portion further including a receiving coupling configured to be releasably secured to a stand;
a parabolic collector connected to the housing element and configured to direct a sound wave toward at least one microphone;
at least one microphone including a pre-amplifier configured to convert a sound wave into an analog electrical signal and amplify the analog electrical signal;
at least one amplifier connected to the audio digital signal processor and configured to increase the power of the analog electrical signal;
the audio digital signal processor configured to:
convert an analog electrical signal into a digital signal;
filtering the digital signal using at least one frequency filter to pass a spectral signature corresponding to a turkey gobble;
compare the filtered digital spectra signature signal to a pre-programmed spectral signature signal corresponding to a turkey gobble using a pre-programmed software algorithm to compare a wavelength of a detected spectra signature signal to a wavelength of a pre-programmed spectral signature corresponding to a turkey gobble using Fourier analysis;
record a time of the detected spectra signature signal using at least one real-time clock.
